(19) United States
(12) Patent Application Publication
(10) Pub. No.: US 2008/0033992 A1
(43) Pub. Date: Feb. 7, 2008

(54) Related Media Content Assets

(75) Inventors: David Hendler Sloo, Menlo Park, CA (US); Jonathan L. Conradt, San Jose, CA (US); Ronald Alan Morris, San Francisco, CA (US); Yi Linda Chan, San Jose, CA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/462,163

(22) Filed: Aug. 3, 2006

(51) Int. Cl. G06F 17/00

(52) U.S. Cl. 707/104.1

(57) ABSTRACT

Related media content assets is described. In an embodiment, an index of media content assets which are associated with defining attributes can be maintained. At least some of the media content assets in the index can have in common one or more of the defining attributes. The media content assets in the index can be related based on the defining attributes. A request can be received from a client device for related media content assets which are related to a selected media content asset playing at the client device. The request can be processed to identify one or more defining attributes of the selected media content asset, and to identify the related media content assets in the index which have in common the one or more defining attributes of the selected media content asset. Identifiers of the related media content assets can be communicated to the client device.

### BACKGROUND

During the past several years, television viewing habits have been rapidly changing in response to advances in technology, and to increased availability of viewing content. Many people now use electronic program guides to help them locate programs and/or other media content assets which are of interest. An electronic program guide (EPG) is an on-screen interactive guide that allows a viewer to navigate among and select media content assets which may be available for viewing and/or recording.

In many cases a viewer will be interested in viewing a particular type of program. For example, the viewer may be particularly interested in watching football games, cooking programs, reality-based programs, or some other type of programming. Currently, when the viewer is watching a program of interest and wants to see what other related or similar programs are available the viewer may press a button on their television controller to display a full-screen EPG. The EPG will list programs according to a schedule which identifies when programs are to be shown, or for video-on-demand (VOD) programs the EPG may list the VOD programs by category. The viewer may then select a similar program from among the programs displayed in the list. Alternatively, the viewer may press a channel-up or channel-down button on their television controller to tune away from the program the viewer is watching. The viewer may then continue pressing the channel-up and/or channel-down button to move from one program to another, until the viewer finds another similar program to watch.

### SUMMARY

This summary is provided to introduce simplified concepts of related media content assets which are further described below in the Detailed Description. This summary is not intended to identify essential features of the claimed subject matter, nor is it intended for use in determining the scope of the claimed subject matter.

In an embodiment, an index of media content assets which are associated with defining attributes can be maintained. At least some of the media content assets in the index can have in common one or more of the defining attributes. The media content assets in the index can be related to one another based on the defining attributes. A request can be received from a client device for related media content assets which are related to a selected media content asset playing at the client device. The request can be processed to identify one or more defining attributes of the selected media content asset, and to identify the related media content assets in the index which have in common the one or more defining attributes of the selected media content asset. Identifiers of the related media content assets can then be communicated to the client device in response to the request.

### BRIEF DESCRIPTION OF THE DRAWINGS

The same numbers are used throughout the drawings to reference like features and components:

FIG. 1 illustrates an exemplary television-based system in which embodiments of related media content assets can be implemented.

FIG. 2 illustrates an exemplary television-based system in which further aspects of embodiments of related media content assets are described.

FIG. 3 illustrates exemplary displays in which further aspects of embodiments of related media content assets are described.

FIG. 4 illustrates exemplary displays in which further aspects of embodiments of related media content assets are described.

FIG. 5 illustrates exemplary method(s) for related media content assets.

FIG. 6 illustrates exemplary method(s) for related media content assets.

FIG. 7 illustrates an exemplary IP-based television (IPTV) system in which embodiments of related media content assets can be implemented.

FIG. 8 illustrates various components of an exemplary client device in which embodiments of related media content assets can be implemented.

FIG. 9 illustrates various devices and components in an exemplary entertainment and information system in which embodiments of related media content assets can be implemented.

### DETAILED DESCRIPTION

Related media content assets is described in which embodiments provide that a viewer who is watching a selected program can initiate a request for related programs while the selected program is displaying for the viewer. In response to the request, the viewer is presented with one or more related programs which can be displayed as pictures-in-pictures while the selected program is displaying. The viewer can therefore easily navigate from one piece of video content to another related piece of video content without “moving away from” the selected program. Related media content assets avoids the “move away from content” which occurs with prior navigation techniques, and enhances the viewing experience by avoiding the disruption in continuity that presently occurs when a viewer navigates from one selected program of interest to another related program.

Embodiments of related media content assets provide that an index of media content assets which are associated with defining attributes is maintained, and at least some of the media content assets in the index have in common one or more of the defining attributes. For example, the index can include a variety of televised programs including some football games which have in common the defining attribute “football”. The media content assets in the index are related to one another based on the defining attributes. Thus, the football games can be related to one another based on the defining attribute “football”. A request is received from a client device for related media content assets which are related to a selected media content asset displaying at the client device. For example, a viewer watching a particular football game may initiate a request to find other football games. The request is processed to identify one or more defining attributes of the selected media content asset, and to identify the related media content assets in the index which have in common the one or more defining attributes of the selected media content asset. For example, the request can be processed to identify the defining attribute “football” which is associated with the particular football game the viewer is watching, and to identify the other football games in the index. Identifiers of the related media content assets are then communicated to the client device in response to the request. For example, identifiers of the other football games can be communicated to the client device so that one or more of the other football games can be identified and displayed to the viewer as pictures-in-pictures while the particular football game continues to be displayed for the viewer.

In the context of this document, media content assets can include any form of on-demand and/or broadcast media content contents such as television programs, movies, commercials, music, and/or similar audio, video, and/or image content that may be provided for viewing and/or listening. In addition, media content assets can include video and/or audio representations of merchandise items and/or services which are in some way related to one or more of the on-demand and/or broadcast media content assets.

While aspects of the described systems and methods for related media content assets can be implemented in any number of different computing systems, environments, television-based entertainment systems, and/or configurations, embodiments of related media content assets are described in the context of the following exemplary systems and environments.

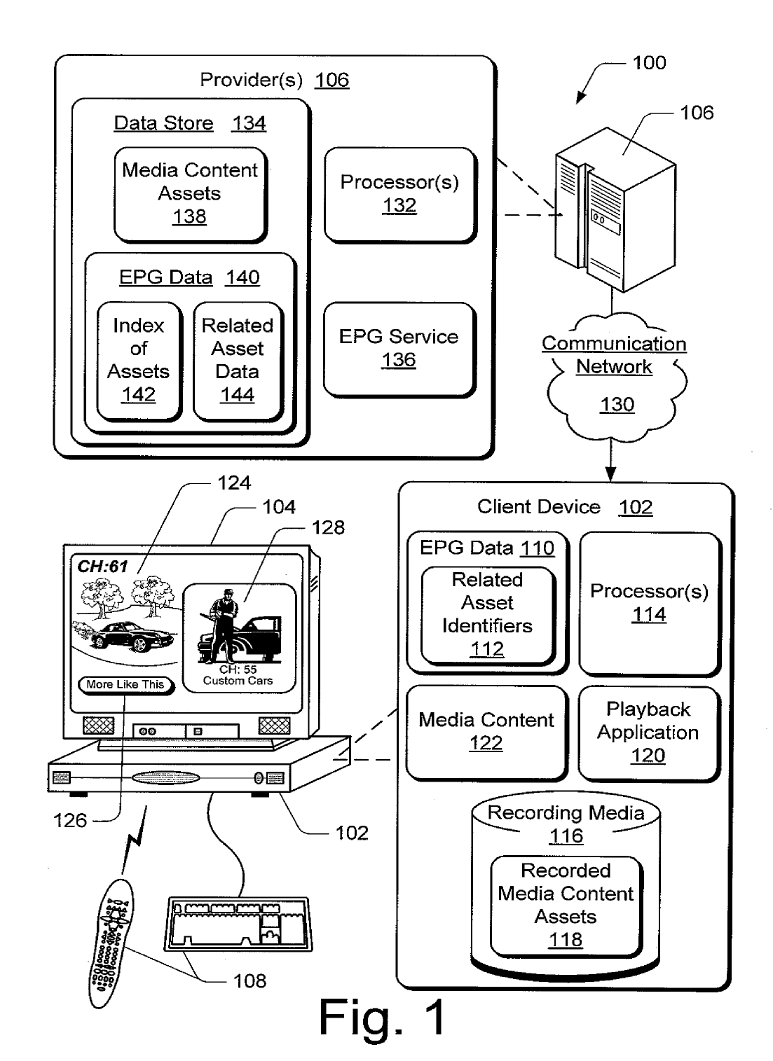

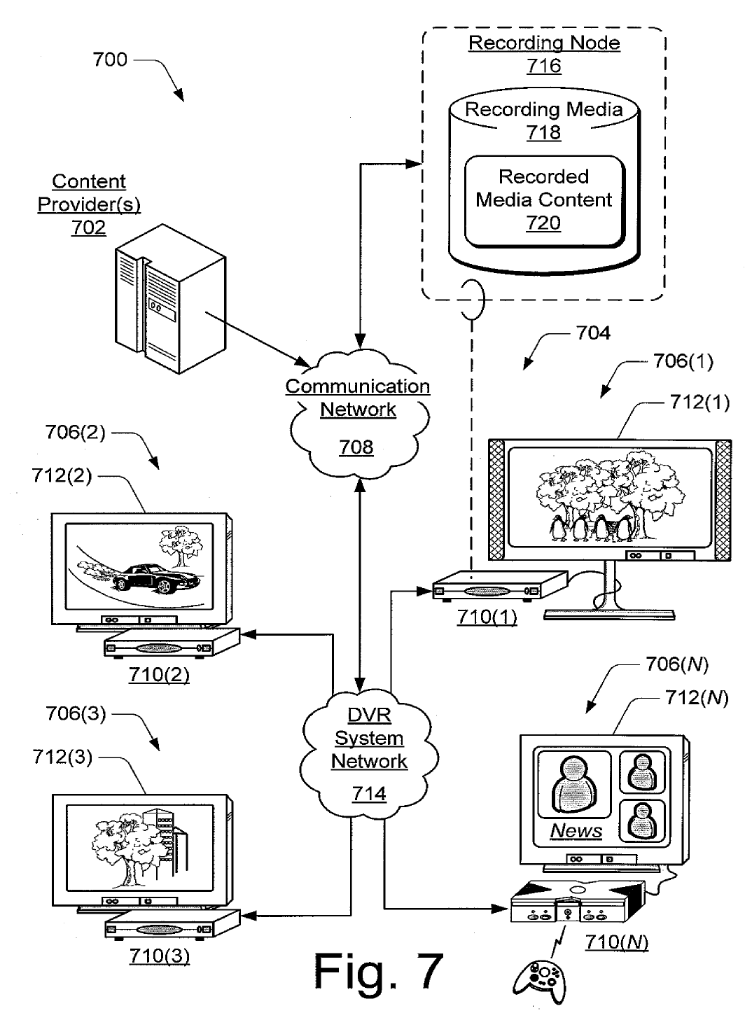

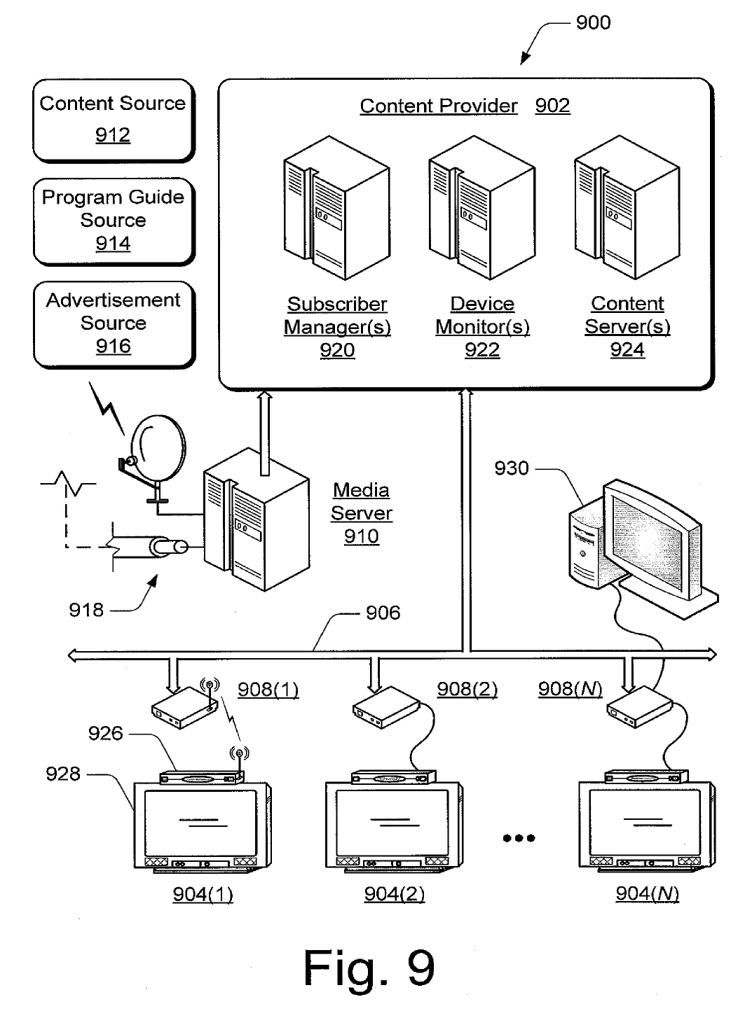

FIG. 1 illustrates an exemplary system 100 in which embodiments of related media content assets can be implemented. The system 100 includes a television-based client device 102, a display device 104, provider(s) or server(s) 106, and input devices 108, such as a remote control device and a computer keyboard. The display device 104 can be any type of television, LCD, or similar television-based display system that renders audio, video, and/or image data. The client device 102 and display device 104 together are but one example of a television-based client system, examples of which are described with reference to the exemplary IP-based television (IPTV) system 700 shown in FIG. 7, and with reference to the exemplary entertainment and information system 900 shown in FIG. 9.

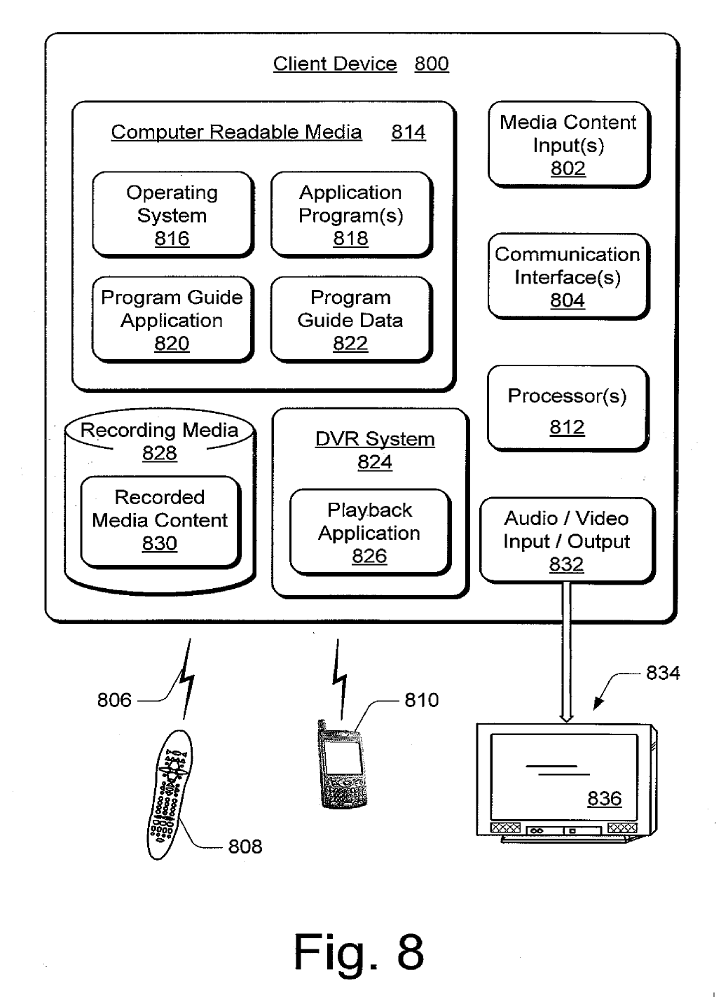

Client device 102 can be implemented in any number of embodiments, such as a set-top box, a digital video recorder (DVR) and playback system, an appliance device, a gaming device, and as any other type of client device that may be implemented in a television-based entertainment and information system. In this example, client device 102 includes EPG data 110 which includes related asset identifiers 112. The EPG data 110 and the related asset identifiers 112 are communicated from the provider 106 to the client device 102. The related assets identifiers 112 identify related media content assets (i.e., media content assets which are in some way related to a selected media content asset which is currently displaying) which can be displayed at the client device 102. The client device 102 also includes one or more processor(s) 114, recording media 116 that maintains recorded media content assets 118, and a playback application 120 which can be implemented as computer executable instructions and executed by the processor(s) 114 to implement embodiments of related media content assets. Additionally, client device 102 may be implemented with any number and combination of differing components as further described below with reference to the exemplary client device 800 shown in FIG. 8.

Recording media 116 along with the playback application 120 can be implemented as a DVR system to record and maintain the recorded media content assets 118 which may be any form of on-demand and/or broadcast media content 122 such as programs, movies, commercials, music, and similar audio, video, and/or image content that client device 102 receives and/or records. Further, client device 102 may access or receive additional recorded media content that is maintained with a remote data store located at provider(s) 106. Still further client device 102 may access or receive additional recorded media content that is maintained with a video-on-demand server or media content that is maintained at a broadcast center or content provider that distributes the media content to subscriber sites and client devices.

The playback application 120 is a video control application that, in this example, can be implemented to control the playback of media content 122, the recorded media content assets 118, and or other video on-demand media content, music, and any other audio, video, and/or image media content which can be rendered and/or displayed for viewing on display device 104. In the illustrated example, the display device 104 is displaying a selected media content asset 124 (e.g. a program entitled “Sports Cars” on channel 61). The display device 104 can also display an on-screen browse mechanism or “more like this” button 126 which can be selected to view one or more related media content assets 128 as a picture-in-picture while the selected media content asset 124 is displaying. In the example, the more-like-this button 126 has been selected so that the related media content asset 128 (e.g., another program related to “cars” and entitled “Custom Cars” on channel 55) is displaying as a picture-in-picture.

The television-based client device 102 is configured for communication with the provider(s) or server(s) 106 via a communication network 130, which in this example, is an IP-based network. The client device 102 can receive programs, associated program content, various forms of media content, program guide data, advertising content, and other media content from the provider(s) 106 via the IP-based network 130.

The provider 106 includes one or more processor(s) 132, a data store 134, and an electronic program guide service 136 which can be implemented as computer executable instructions and executed by the processor(s) 132 to implement embodiments of related media content assets. The data store 134 can store media content assets 138 which can be communicated to the client device 102. The provider 106 also includes EPG data 140 which can be communicated from the provider 106 to the client device 102 via the communication network 130. The EPG data 140 includes an index of media content assets 142 which can be used for relating the media content assets 138 to one another. The EPG data 140 can also include related asset data 144 which identifies which of the media content assets 138 are related to one another.

Although the media content assets 138 and the EPG data 140 are each illustrated and described as being stored in a single data store 134, each of the media content assets 138 and the EPG data 140 can be stored in various formats and/or distributed among various data stores. Further, although the EPG service 136 is illustrated and described as a single application program, the EPG service 136 can be implemented as several component applications distributed to perform one or more of the functions described in various embodiments of related media content assets. In one embodiment, the EPG service 136 of the provider 106 is configured to relate the media content assets 138 to one another based on defining attributes of the media content assets 138.

Although the provider(s) 106 are illustrated and described as a single provider 106 which determines which of the media content assets 138 are related to one another and then provides the media content assets 138 to the client device 102, these processes can be performed by two different providers 106 and/or the processes can be distributed among multiple providers 106. For example, in one implementation a viewer-initiated request to determine related media content assets can be sent to a provider 106 (e.g., a movie reviewer) that determines which media content assets 138 are related to a selected media content asset 124 currently playing at the client device 102 and provides a reference (e.g., identifiers) to the related media content assets, while one or more different provider(s) 106 (e.g., content providers) provide the actual related media content assets to the client device 102.

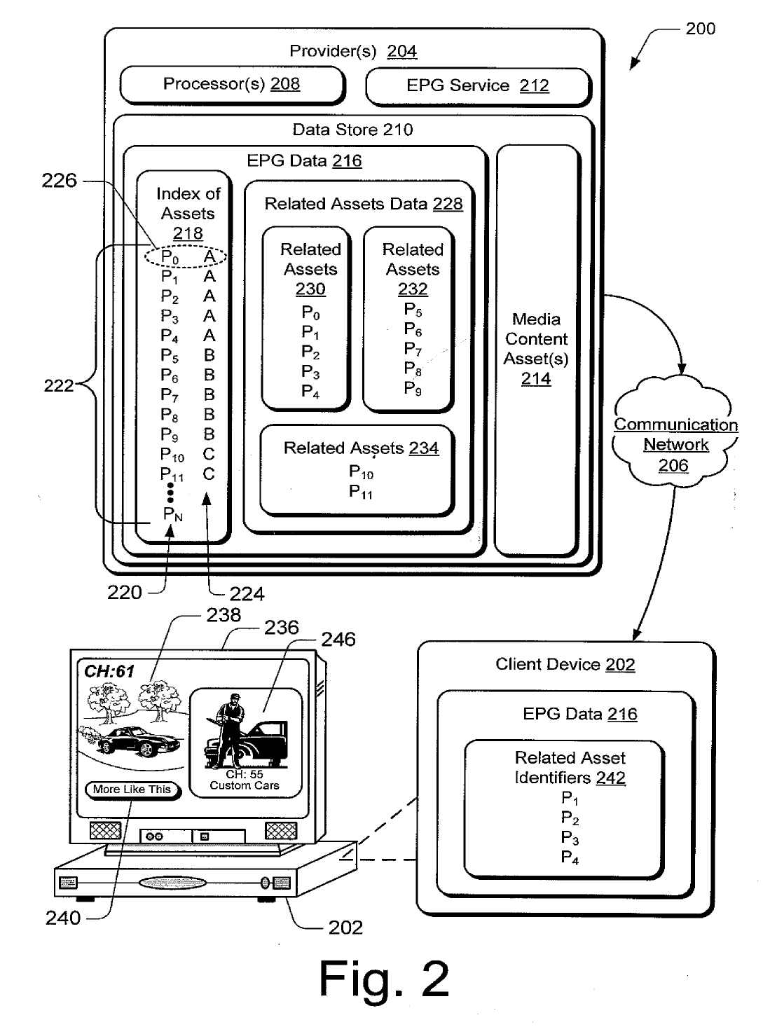

FIG. 2 illustrates an exemplary television-based system 200 in which further aspects of embodiments of related media content assets are described. The system 200 includes a television-based client device 202 and provider(s) 204. The television-based client device 202 is configured for communication with the provider 204 via an IP-based communication network 206. The television-based client device 202 can include any of the components and/or modules described with reference to client device 102 of FIG. 1, and the provider(s) 204 can include any of the components and/or modules described with reference to provider(s) 106 of FIG. 1.

As illustrated, the provider 204 includes one or more processor(s) 208, a data store 210, and an electronic program guide (EPG) service 212 which can be implemented as computer executable instructions and executed by the processor(s) 208 to implement embodiments of related media content assets. The data store 210 can store media content assets 214 and EPG data 216, both of which can be communicated from the provider 204 to the client device 202 via communication network 206.

The EPG data 216 includes an index of media content assets 218. The index 218 includes a list 220 of identifiers 222 (e.g., identifiers P₀-P_{N}) which respectively identify each of the media content assets 214. For example, identifier P₀ identifies one media content asset 214, identifier P₁ identifies another media content asset 214, identifier P₂ identifies another media content asset 214, and so forth. In other words, the identifiers 222 (e.g., identifiers P₀-P_{N}) of index 218 correlate to and identify the media content assets 214.

In addition, each of the identifiers 222 (e.g., identifiers P₀-P_{N}) are associated with one or more defining attributes 224. In the illustrated example, the defining attributes 224 are represented by letters (e.g., “A”, “B”, and “C”). For example, as shown by reference number 226, the identifier “P₀” is associated with the letter “A” which can represent a particular defining attribute of the identified media content asset. Each of the identifiers 222 can be associated with one or more defining attributes 224. At least some of the media content assets 214 have in common the one or more of the defining attributes 224. Accordingly, at least some of the identifiers 222 have in common the one or more of the defining attributes 224.

In the illustrated example, identifiers P₀-P₄ are each associated with the defining attribute represented by the letter “A”, identifiers P₅-P₉ are each associated with the defining attribute represented by the letter “B”, and identifiers P₁₀-P₁₁ are each associated with the defining attribute represented by the letter “C”. In other words, the media content assets 214 represented by identifiers P₀-P₄ have in common the defining attribute “A”, the media content assets 214 represented by identifiers P₅-P₉ have in common the defining attribute “B”, and the media content assets 214 represented by identifiers P₁₀-P₁₁ have in common the defining attribute “C”.

At the provider 204, the media content assets 214 represented by the identifiers 222 in the index 218 can be related to one another based on the defining attributes 224 which they have in common. The EPG service 212 can be implemented as computer executable instructions and executed by the processor(s) 208 to relate the media content assets 214 represented by the identifiers 222 in the index 218 to one another based on the defining attributes 224. In the illustrated example, the media content assets 214 represented by the identifiers 222 in the index 218 are related to one another based on the defining attributes 224 as related assets data 228. For example, the media content assets 214 represented by identifiers P₀-P₄ have in common the defining attribute “A”, and can be placed in a first group of related assets 230. The media content assets 214 represented by identifiers P₅-P₉ have in common the defining attribute “B”, and can be placed in a second group of related assets 232. The media content assets 214 represented by identifiers P₁₀-P₁₁ have in common the defining attribute “C”, and can be placed in a third group of related assets 234.

The relating of the media content assets 214 (which are represented in the index 218) can be based on any type of defining attributes 224 which are included as part of the indexing process. For example, the relating of the media content assets 214 can be based on one or more defining attributes 224 which can include: matching text of the media content assets 214, a duration of time that the media content assets 214 are viewed, a time of day that the media content assets 214 are viewed, and/or a day of a week that the media content assets 214 are viewed. As additional examples, the relating of the media content assets 214 can be based on one or more defining attributes which can include: title, description, lead actor, director, producer, rating, reviews, program category, and language. The relating of the media content assets 214 can be based on one metric or on any number of metrics.

Embodiments of related media content assets provide that the relating of the media content assets 214 represented in the index 218 can occur prior to receiving a request for related assets from the client device 202. Other embodiments of related media content assets provide that the relating of the media content assets 214 represented in the index 218 can occur in response to receiving the request for related assets from the client device 202. Still other embodiments contemplate that some relating of the media content assets 214 represented in the index 218 can occur prior to receiving the request from the client device 202, while other relating of the media content assets 214 represented in the index 218 can occur in response to receiving the request from the client device 202.

The system 200 includes a display device 236, and can also include input devices such as a remote control device and a computer keyboard (not shown). The display device 236 can be any type of television, LCD, or similar television-based display system that renders audio, video, and/or image data. The client device 202 and display device 236 together are but one example of a television-based client system, examples of which are described with reference to the exemplary IP-based television (IPTV) system 700 shown in FIG. 7, and with reference to the exemplary entertainment and information system 900 shown in FIG. 9. Additionally, client device 202 may be implemented with any number and combination of differing components as further described below with reference to the exemplary client device 800 shown in FIG. 8.

In FIG. 2, the display device 236 is displaying a selected media content asset 238 at the client device 202 which a viewer has selected. The selected media content asset 238 is a program entitled “Sports Cars” which is being shown on channel 61. The display device 236 can also display an on-screen browse mechanism or such as a “more like this” button 240 which can be selected by the viewer to initiate a request for related media content assets which are related to the selected media content asset 238. Once the viewer has selected the “more-like-this” button 240, a viewer-initiated request is communicated to the provider 204. The provider 204 receives the request, and determines the related media content assets based on one or more defining attributes 224 of the selected media content asset 238 which are identified in the request. In FIG. 2, the selected media content asset 238 (e.g., the program entitled “Sports Cars” which is being shown on channel 61) is identified in the index 218 by identifier P₀. Identifier P₀ is associated with defining attribute “A” in the index 218. In the present example, defining attribute “A” identifies the media content assets which are related to “cars”.

The provider 204 determines which of the media content assets 214 represented in the index 218 are related to the selected media content asset 238 which is identified in the request. In the present example, the EPG service 212 can be implemented as computer executable instructions and executed by the processor(s) 208 to relate the media content assets 214 represented by the identifiers 222 in the index 218 to one another based on the defining attributes 224, and to determine which of the media content assets 214 are related to the selected media content asset 238. In the present example, the electronic program guide service 212 identifies the media content assets 214 represented by identifiers P₀-P₄ in the index 218 as having in common the defining attribute “A” (e.g., as being related to “cars”). The media content assets 214 represented by identifiers P₀-P₄ are identified as belonging to the first group of related assets 230. The provider 204 sends a response to the client device 202 which includes related asset identifiers 242. The related asset identifiers 242 which are communicated to the client device 202 identify the media content assets 214 which were determined to be related to the selected media content asset 238. Accordingly, related asset identifiers 242 (e.g., identifiers P₁, P₂, P₃, and P₄) are communicated to the client device 202. The related asset identifiers P₀ does not need to be included with the other related asset identifiers 242 since the selected media content asset 238 (i.e., the program entitled “Sports Cars” which is being shown on channel 61) which is associated with identifier P₀ is already displaying at the client device 202.

The client device 202 receives the response from the provider 204 which includes related asset identifiers 242. The related asset identifiers 242 (e.g., identifiers P₁, P₂, P₃, and P₄) identify the related media content assets 214 which have been determined to be related to the selected media content asset 238. The client device 202 can then display one or more of the related media content assets 214 identified by the related asset identifiers 242 (e.g., identifiers P₁, P₂, P₃, and P₄) while the selected media content asset 238 (associated with identifier P₀) is displaying at the client device 202. In the illustrated example, a related media content asset 246 which has been identified by the related asset identifiers 242 is displaying. The related media content asset 246 is a program entitled “Custom Cars” which is being displaying as a picture-in-picture while the selected program 238 “Sports Cars” is displaying. Thus, in the present example, the selected program 238 entitled “Sports Cars” and the related program 246 entitled “Custom Cars” are related by the defining attribute “A” which indicates that both programs are related to “cars”.

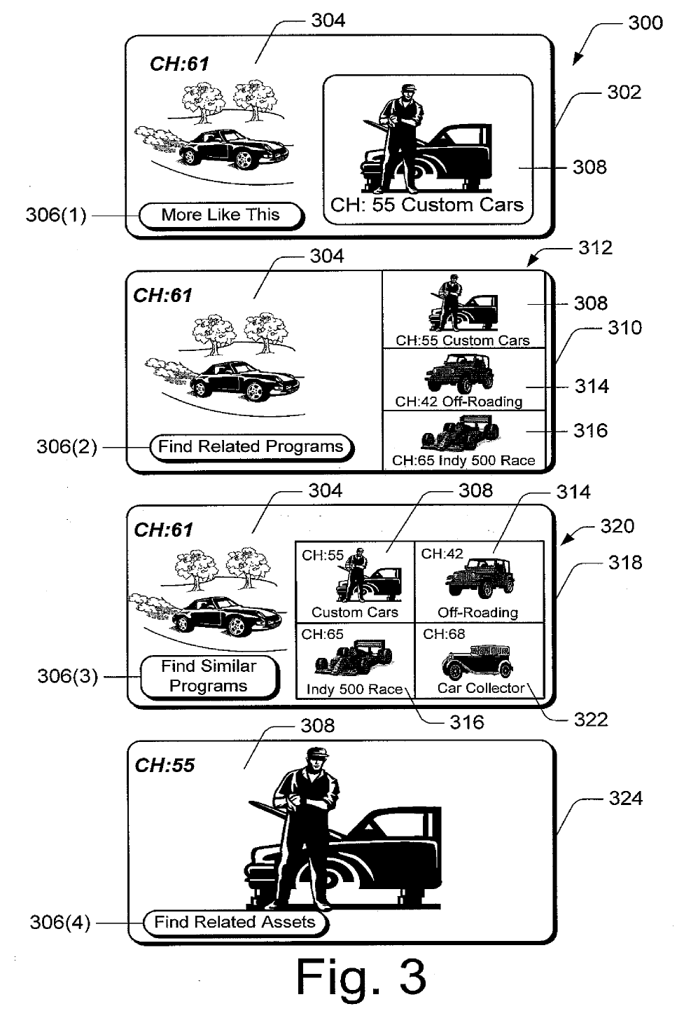

FIG. 3 illustrates exemplary displays 300 in which further aspects of embodiments of related media content assets are described. The exemplary displays can be presented to the viewer via a display device (such as display device 236 of FIG. 2) while navigating to related media content assets. The viewer can scroll up or scroll down or scroll side-to-side among picture-in-picture displays of related media content assets using an input device (e.g., such as the remote control device and/or computer keyboard 108 of FIG. 1) to view additional related media content assets and/or to make selections.

At exemplary display 302, the viewer has selected a media content asset 304 which is the program entitled “Sports Cars” which is being shown on channel 61. The viewer has initiated a search for related media content assets by selecting an on-screen browse mechanism such as “more like this” button 306(1) which can be selected to view one or more related media content assets 308 as a picture-in-picture while the selected media content asset 304 is displaying. In the exemplary display 302, the more like this button 306(1) has been selected so that the related media content asset 308 is displaying as a picture-in-picture. Here the related media content asset 308 is another program entitled “Custom Cars” on channel 55.

At exemplary display 310, the viewer has selected the media content asset 304 which is the program entitled “Sports Cars” which is being shown on channel 61. The viewer has initiated a search for related media content assets by selecting a “find related programs” button 306(2) to view one or more related media content assets 312 as pictures-in-pictures while the selected media content asset 304 is displaying. Here the related media content assets 312 include three programs which are related to the selected program 304, and the three programs are displaying as pictures-in-pictures in a “film-strip format”. The first program 308 displaying is the program entitled “Custom Cars” on channel 55, the second program 314 displaying is a program entitled “Off-Roading” on channel 42, and the third program 316 displaying is a program entitled “Indy 500 Race” on channel 65.

At exemplary display 318, the viewer has selected the media content asset 304 which is the program entitled “Sports Cars” which is being shown on channel 61. The viewer has initiated the search for related media content assets by selecting a “find similar programs” button 306(3), and related media content assets 320 are displaying as pictures-in-pictures. Here the related media content assets 320 include four programs which are related to the selected program 304, and are displaying as pictures-in-pictures in a “mosaic format”. The first program 308 displaying is the program entitled “Custom Cars” on channel 55, the second program 314 displaying is the program entitled “Off-Roading” on channel 42, the third program 316 displaying is the program entitled “Indy 500 Race” on channel 65, and the fourth program 322 displaying is a program entitled “Car Collector” on channel 68.

At exemplary display 324, the viewer has selected the related media content asset 308 (e.g., the program entitled “Custom Cars” on channel 55) from one of the earlier displays (e.g., displays 302, 310 or 318). The related media content assets 308 can then displayed as a full-screen display as shown at exemplary display 324. In addition, a “find related assets” button 306(4) can be displayed, and can be selected by the viewer to initiate a search for related media content assets.

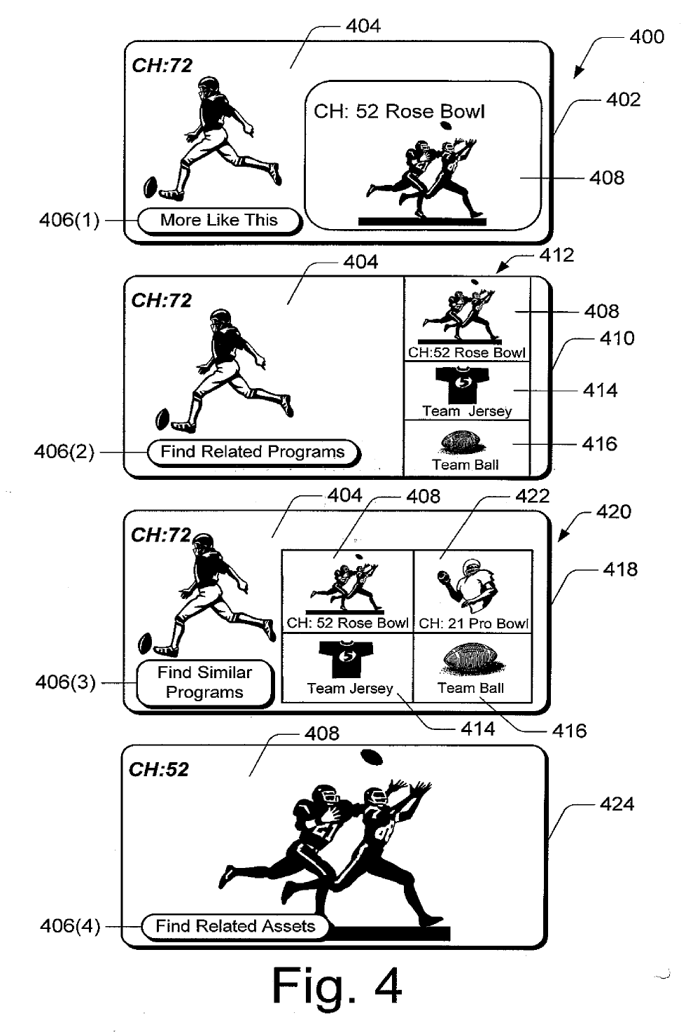

FIG. 4 illustrates exemplary displays 400 in which further aspects of embodiments of related media content assets are described. The exemplary displays can be presented to the viewer via a display device (such as display device 236 of FIG. 2) while navigating to related media content assets. The viewer can scroll up or scroll down or scroll side-to-side among the picture-in-picture displays of related media content assets using an input device (e.g., such as the remote control device and/or computer keyboard 108 of FIG. 1) to view additional related media content assets and/or to make selections.

At exemplary display 402, the viewer has selected a media content asset 404 which is program entitled “College Football” which is being shown on channel 72. The viewer has initiated a search for related media content assets by selecting an on-screen browse mechanism such as “more like this” button 406(1) which can be selected to view one or more related media content assets 408 as a picture-in-picture while the selected media content asset 404 is displaying. In the exemplary display 402, the more-like-this button 406(1) has been selected so that the related media content asset 408 is displaying as a picture-in-picture. Here the related media content asset 408 is another program entitled the “Rose Bowl” which is on channel 52.

At exemplary display 410, the viewer has selected the media content asset 404 which is the program entitled “College Football” which is being shown on channel 72. The viewer has initiated a search for related media content assets by selecting an on-screen browse mechanism such as a “find related programs” button 406(2) which can be selected to view one or more related media content assets as a picture-in-picture while the selected media content asset 404 is displaying. In the exemplary display 410, the find related programs button 406(2) has been selected so that the related media content assets 412 are displaying as pictures-in-pictures. Here the related media content assets 412 include media content assets which are related to the selected program 404, and are displaying as pictures-in-pictures in a “film-strip format”. The first related media content asset 408 displaying is the program entitled “Rose Bowl” on channel 52, the second related media content asset 414 displaying is a merchandise item entitled “Team Jersey” which may be selected if the viewer is interested in learning more about the item and/or would like to ordered/purchased the item, and the third related media content asset 416 displaying is a merchandise item entitled “Team Ball” which may be selected if the viewer is interested in learning more about the item and/or would like to ordered/purchased the item.

At exemplary display 418, the viewer has selected the media content asset 404 which is the program entitled “College Football” which is being shown on channel 72. The viewer has initiated a search for related media content assets by selecting an on-screen browse mechanism such as a “find similar programs” button 406(3) which can be selected to view one or more related media content assets as a picture-in-picture while the selected media content asset 404 is displaying. In the exemplary display 418, the find similar programs button 406(3) has been selected so that the related media content assets 420 are displaying as pictures-in-pictures. Here the related media content assets 420 include media content assets which are related to the selected program 404, and are displaying as pictures-in-pictures in a “mosaic format”. The first related media content asset 408 displaying is the program entitled “Rose Bowl” on channel 52, the second related media content asset 414 displaying is a merchandise item entitled “Team Jersey” which may be selected if the viewer is interested in learning more about the item and/or would like to ordered/purchased the item, the third related media content asset 416 displaying is a merchandise item entitled “Team Ball” which may be selected if the viewer is interested in learning more about the item and/or would like to ordered/purchased the item, and the fourth related media content asset 422 displaying is a program entitled “Pro Bowl” on channel 21.

At exemplary display 424, the viewer has selected the related media content asset 408 from one of the earlier displays (e.g., displays 402, 410 or 418). The related media content assets 408 can then displayed as a full-screen display as illustrated at the exemplary display 424. In addition, a “find related assets” button 406(4) can be displayed, and can be selected by the viewer to initiate a search for related media content assets.

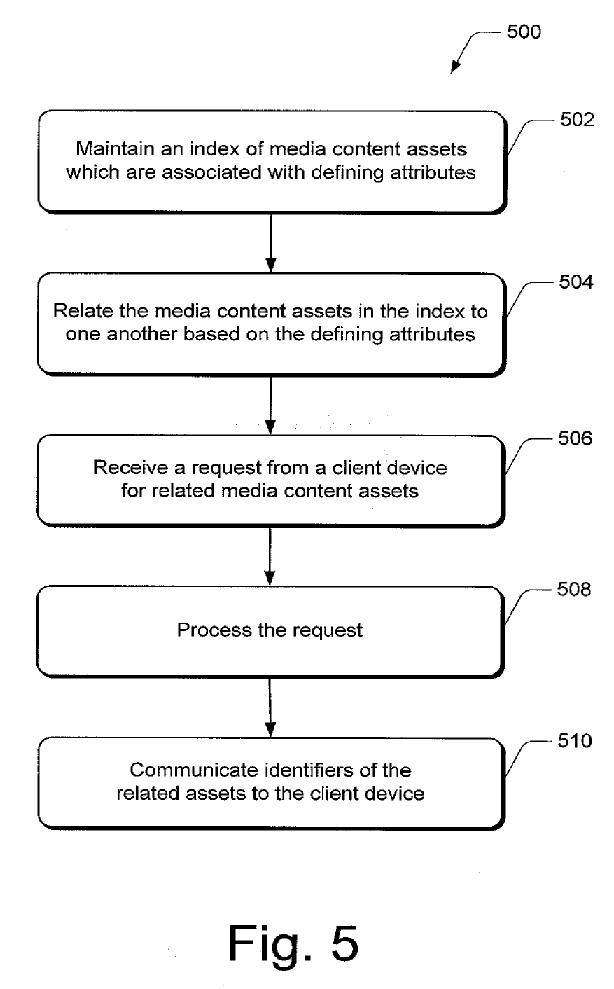

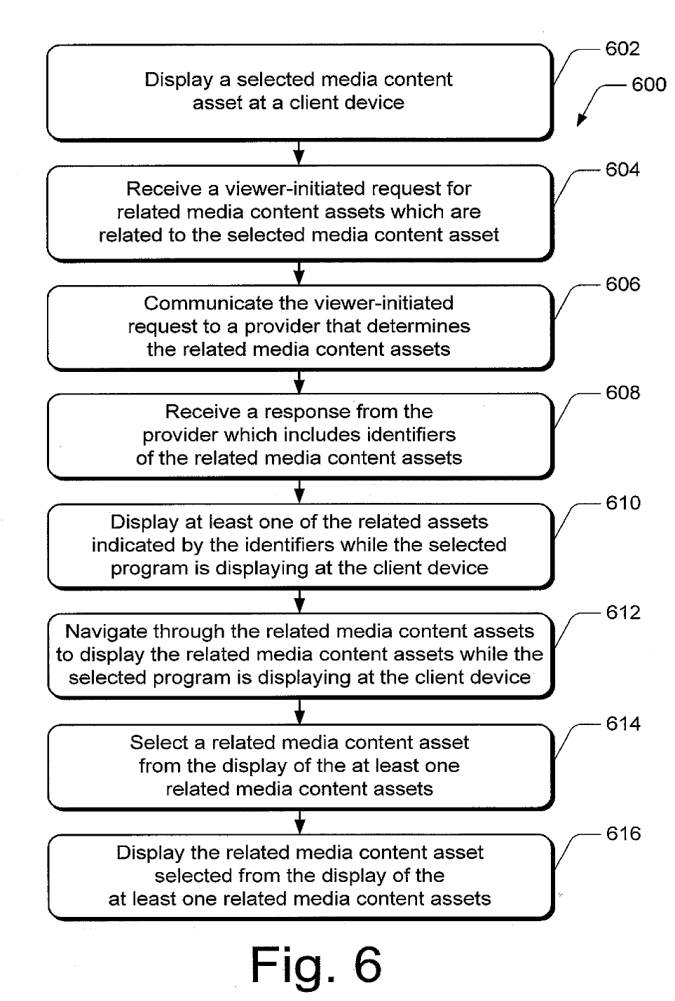

Methods for related media content assets, such as exemplary methods 500 and 600 described with reference to respective FIGS. 5 and 6, may be described in the general context of computer executable instructions. Generally, computer executable instructions can include routines, programs, objects, components, data structures, procedures, modules, functions, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

FIG. 5 illustrates an exemplary method 500 for related media content assets and is described with reference to the exemplary system 200 shown in FIG. 2. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 502, an index of media content assets which are associated with defining attributes is maintained, such that at least some of the media content assets in the index have in common one or more of the defining attributes. For example, the index of media content assets 218 can be maintained at the provider 204. The media content assets 214 are represented by identifiers 222 in the index 218, and at least some of the media content assets 214 represented by the identifiers 222 have in common one or more defining attributes 224.

At block 504, the media content assets in the index are related to one another based on the defining attributes. For example, the media content assets 214 represented in the index 218 can be related to one another based on the defining attributes 224. For example, the first group of related assets 230 includes several identifiers (i.e., identifiers P₁, P₂, P₃, and P₄) of media content assets 214 which have been related to one another based on having a common defining attribute 224 (e.g., the defining attribute represented by the letter “A”, which may represent for example, media content assets associated with “cars”).

At block 506, a request is received from a client device for related media content assets which are related to a selected media content asset at the client device. For example, the provider 204 can receive a request for media content assets which are related to a program 238 (e.g., a program entitled “Sports Cars”) displaying at the client device 202.

At block 508, the request is processed to identify one or more defining attributes of the selected media content asset, and to identify the related media content assets in the index which have in common the one or more defining attributes of the selected media content asset. For example, the EPG service 212 at the provider 204 can be implemented as computer executable instructions and executed by the processor(s) 208 to process the request by identify one or more defining attributes 224 of the selected media content asset 238 (e.g., the program entitled “Sports Cars”), and relating the media content assets 214 represented by the identifiers 222 in the index 218 to one another based on the defining attributes 224. For example, the EPG service 212 may identify the defining attribute of the selected media content asset 238 as being programs relating to “cars”, and then identify related media content assets in the index which are also related to “cars”.

At block 510, identifiers of the related media content assets are communicated to the client device in response to the request. For example, the related asset identifiers 242 can be communicated to the client device 202 to identify the media content assets 214 which were determined to be related to the selected media content asset 238. Such a group related media content assets are represented by the first group of related assets 230.

FIG. 6 illustrates an exemplary method 600 for related media content assets and is described with reference to the exemplary system 200 shown in FIG. 2, and with reference to the exemplary displays 300 shown in FIG. 3. The order in which the method is described is not intended to be construed as a limitation, and any number of the described method blocks can be combined in any order to implement the method, or an alternate method. Furthermore, the method can be implemented in any suitable hardware, software, firmware, or combination thereof.

At block 602, a selected media content asset is displayed at a client device. For example, the selected media content asset 238 (e.g., a program entitled “Sports Cars” is displaying at client device 202.

At block 604, a viewer-initiated request for related media content assets which are related to the selected media content asset is received. For example, the display device 236 can also display a “more like this” button 240 which can be selected by the viewer to initiate a request for related media content assets which are related to the selected media content asset 238. Once the viewer has selected the “more-like-this” button 240, the viewer-initiated request is received at the client device 202.

At block 606, the viewer initiated request is communicated to a provider that determines the related media content assets. For example, the viewer imitated request can be communicated via the communication network 206, to a provider 204 that determines the related media content assets.

At block 608, a response is received from the provider which includes identifiers of the related media content assets determined to be related to the selected media content asset. For example, the client device 202 can receive related asset identifiers 242 from the provider 204.

At block 610, at least one of the related media content assets indicated by the identifiers is displayed while the selected program is displaying at the client device. For example, a related media content asset 246 (e.g., a program entitled “Custom Cars”) can be displayed as a picture-in-picture while the selected program 238 (e.g., a program entitled “Sports Cars”) is displaying. An exemplary display 236 is illustrated at FIG. 2.

At block 612, the related media content assets are navigated to display the related media content assets while the selected program is displaying at the client device. For example, exemplary display 318 illustrates displaying the related media content assets 320 in a mosaic format. The viewer can scroll up or scroll down or scroll side-to-side among picture-in-picture displays of related media content assets 320 presented in the mosaic format using an input device to view additional related media content assets and/or to make selections.

At block 614, a related media content asset is selected from the display of the at least one related media content assets. For example, at exemplary display 318 the viewer can select related media content asset 308 (e.g., a program entitled “Custom Cars”) from the mosaic of related media content assets 320.

At block 616, the related media content asset selected from the display of the at least one related media content assets is displayed. For example, at exemplary display 324, the related media content asset selected 308 from the mosaic of related media content assets 320 is displayed as a full-screen display.

FIG. 7 illustrates an exemplary IP-based television (IPTV) environment 700 in which embodiments of related media content assets can be implemented. The IPTV environment 700 includes content provider(s) 702 and a multi-DVR system 704 that can include any number of television-based client systems 706(1-N). The multi-DVR system 704 can represent a household viewing system that has several viewing areas, such as different rooms, for viewing television programs. The multi-DVR system 704 is configured for communication with any number of the different content provider(s) 702 via a communication network 708 which, in this example, is an IP-based network. Any of the systems and/or devices can be configured for network access in any number of embodiments and varieties of implementation.

The television-based client systems 706(1-N) of the multi-DVR system 704 are representative of DVR nodes in a multi-DVR system. Each of the DVR nodes of the multi-DVR system 704 can communicate with each other to act and make decisions on behalf of the other nodes, for the overall common good of the multi-DVR system 704, and based on the state of individual nodes and/or based on the state of the multi-DVR system 704.

The television-based client system 706(1) includes a television-based client device 710(1) and a display device 712(1), such as any type of television, monitor, LCD, or similar television-based display system that together renders audio, video, and/or image data. Similarly, the television-based client systems 706(2-N) each include a respective television-based client device 710(2-N) and a respective display device 712(2-N). Each television-based client device 710 can be implemented in any number of embodiments, such as a television-based set-top box, a digital video recorder (DVR) and playback system, an appliance device, a gaming system such as client device 710(N), and as any other type of client device that may be implemented in a television-based entertainment and information system.

The television-based client devices 710(1-N) of the television-based client systems 706(1-N) can be implemented for communication with each other via a DVR system network 714, and may be implemented with any number and combination of differing components as further described below with reference to the exemplary client device shown in FIG. 8. Further, the IPTV environment 700 may be implemented with any number and combination of differing components as described below with reference to the exemplary entertainment and information system shown in FIG. 9.

A television-based client system 706 at a node of the multi-DVR system 704 can receive programs, associated program content, various forms of media content, program guide data, advertising content, and other types of media content from content server(s) of the content provider(s) 702 via the communication network 708. Media content can include television-based programs (or programming) which may be any form of programs, commercials, music, movies, and video on-demand movies. Other media content can include recorded media content, interactive games, network-based applications, and any other similar audio, video, and/or image content. In addition, media content in general may include music streamed from a computing device to a client device, such as a television-based set-top box, and may also include video on-demand media content delivered from a server, a photo slideshow, and any other audio, video, and/or image content received from any type of media content source.

Although the data streams are not shown specifically, the arrowed communication links illustrate various data communication links which include the data streams. Additionally, the arrowed communication links are not intended to be interpreted as a one-way communication link from the DVR system network 714 to a client device 710(1), for example. It is contemplated that any one or more of the arrowed communication links can facilitate two-way data communication, such as from communication network 708 to a content provider 702.

The multi-DVR system 704 includes a recording node 716 which includes a recording media 718 to maintain recorded media 720. In an embodiment, any one or more of the television-based client devices 710(1-N) in the multi-DVR system 704 can be implemented as the recording node 716 (as shown by the dashed line) which includes the recording media 718 to record media content received from a content provider 702. Alternatively (or in addition), a recording node of the multi-DVR system 704 can be implemented as a network-based recording node that the multi-DVR system 704 can communicate with via the communication network 708. In another implementation, the recording node 716 can be an independent component of the multi-DVR system 704.

The recording node 716 can record media content with the recording media 718 for any one or more of the television-based client devices 710(1-N) of the multi-DVR system 704. For example, a television-based client device 710 can initiate a record request to have media content recorded for a scheduled recording or to record and provide a pause buffer for the television-based client device. The recording node 716 can receive the record request and record the media content such that the television-based client device can access and render the recorded media content from the recording node via the DVR system network 714 and/or the communication network 708.

FIG. 8 illustrates various components of an exemplary client device 800 which can be implemented as any form of a computing, electronic, or television-based client device in which embodiments of related media content assets can be implemented. For example, the client device 800 can be implemented as a television-based client device at a DVR node of the multi-DVR system shown in FIG. 7.

Client device 800 includes one or more media content inputs 802 which may include Internet Protocol (IP) inputs over which streams of media content are received via an IP-based network. Device 800 further includes communication interface(s) 804 which can be implemented as any one or more of a serial and/or parallel interface, a wireless interface any type of network interface, a modem, and as any other type of communication interface. A wireless interface enables client device 800 to receive control input commands 806 and other information from an input device, such as from remote control device 808, a portable computing-based device (such as a cellular phone) 810, or from another infrared (IR), 802.11, Bluetooth, or similar RF input device.

A network interface provides a connection between the client device 800 and a communication network by which other electronic and computing devices can communicate data with device 800. Similarly, a serial and/or parallel interface provides for data communication directly between client device 800 and the other electronic or computing devices. A modem facilitates client device 800 communication with other electronic and computing devices via a conventional telephone line, a DSL connection, cable, and/or other type of connection.

Client device 800 also includes one or more processors 812 (e.g., any of microprocessors, controllers, and the like) which process various computer executable instructions to control the operation of device 800, to communicate with other electronic and computing devices, and to implement embodiments of multi-DVR node communication. Client device 800 can be implemented with computer readable media 814, such as one or more memory components, examples of which include random access memory (RAM), non-volatile memory (e.g., any one or more of a read-only memory (ROM), flash memory, EPROM, EEPROM, etc.), and a disk storage device. A disk storage device can include any type of magnetic or optical storage device, such as a hard disk drive, a recordable and/or rewriteable compact disc (CD), a DVD, a DVD+RW, and the like.

Computer readable media 814 provides data storage mechanisms to store various information and/or data such as software applications and any other types of information and data related to operational aspects of client device 800. For example, an operating system 816 and/or other application programs 818 can be maintained as software applications with the computer readable media 814 and executed on processor(s) 812 to implement embodiments of multi-DVR node communication.

For example, client device 800 can be implemented to include a program guide application 820 that is implemented to process program guide data 822 and generate program guides for display which enable a viewer to navigate through an onscreen display and locate broadcast programs, recorded programs, video on-demand programs and movies, interactive game selections, network-based applications, and other media access information or content of interest to the viewer.

The client device 800 can also include a DVR system 824 with playback application 826, and recording media 828 to maintain recorded media content 830 which may be any form of on-demand and/or media content such as programs, movies, commercials, music, and similar audio, video, and/or image content that client device 800 receives and/or records. Further, client device 800 may access or receive additional recorded media content that is maintained with a remote data store (not shown), such as from a video-on-demand server, or media content that is maintained at a broadcast center or content provider that distributes the media content to subscriber sites and client devices. The playback application 826 is a video control application that can be implemented to control the playback of media content, the recorded media content 830, and or other video on-demand media content, music, and any other audio, video, and/or image media content which can be rendered and/or displayed for viewing.

The client device 800 also includes an audio and/or video output 832 that provides audio and video to an audio rendering and/or display system 834, or to other devices that process, display, and/or otherwise render audio, video, and image data. Video signals and audio signals can be communicated from device 800 to a display device 836 via an RF (radio frequency) link, S-video link, composite video link, component video link, analog audio connection, or other similar communication link. Alternatively, the audio rendering and/or display system 834 is/are integrated components of the exemplary client device 800.

FIG. 9 illustrates an exemplary entertainment and information system 900 in which an IP-based television environment can be implemented, and in which embodiments of related media content assets can be implemented. System 900 facilitates the distribution of media content, program guide data, and advertising content to multiple viewers and to multiple viewing systems. System 900 includes a content provider 902 and television-based client systems 904(1-N) each configured for communication via an IP-based network 906. Each television-based client system 904(1-N) is an example of the television-based client systems 906(1-N) described with reference to FIG. 7. Each of the television-based client systems 904(1-N) can receive one or more data streams from content provider 902 which are then distributed to one or more other television-based client devices at DVR nodes of a multi-DVR system.

The network 906 can be implemented as a wide area network (e.g., the Internet), an intranet, a Digital Subscriber Line (DSL) network infrastructure, or as a point-to-point coupling infrastructure. Additionally, network 906 can be implemented using any type of network topology and any network communication protocol, and can be represented or otherwise implemented as a combination of two or more networks. A digital network can include various hardwired and/or wireless links 908(1-N), routers, gateways, and so on to facilitate communication between content provider 902 and the client systems 904(1-N). The television-based client systems 904(1-N) receive media content, program content, program guide data, advertising content, closed captions data, and the like from content server(s) of the content provider 902 via the IP-based network 906.

System 900 includes a media server 910 that receives media content from a content source 912, program guide data from a program guide source 914, and advertising content from an advertisement source 916. In an embodiment, the media server 910 represents an acquisition server that receives the audio and video media content from content source 912, an EPG server that receives the program guide data from program guide source 914, and/or an advertising management server that receives the advertising content from the advertisement source 916.

The content source 912, the program guide source 914, and the advertisement source 916 control distribution of the media content, the program guide data, and the advertising content to the media server 910 and/or to other television-based servers. The media content, program guide data, and advertising content is distributed via various transmission media 918, such as satellite transmission, radio frequency transmission, cable transmission, and/or via any number of other wired or wireless transmission media. In this example, media server 910 is shown as an independent component of system 900 that communicates the program content, program guide data, and advertising content to content provider 902. In an alternate implementation, media server 910 can be implemented as a component of content provider 902.

Content provider 902 is representative of a headend service in a television-based content distribution system, for example, that provides the media content, program guide data, and advertising content to multiple subscribers (e.g., the television-based client systems 904(1-N)). The content provider 902 can be implemented as a satellite operator, a network television operator, a cable operator, and the like to control distribution of media content, program and advertising content, such as movies, television programs, commercials, music, and other audio, video, and/or image content to the client systems 904(1-N).

Content provider 902 includes various components to facilitate media data processing and content distribution, such as a subscriber manager 920, a device monitor 922, and a content server 924. The subscriber manager 920 manages subscriber data, and the device monitor 922 monitors the client systems 904(1-N) (e.g., and the subscribers), and maintains monitored client state information.

Although the various managers, servers, and monitors of content provider 902 (to include the media server 910 in one embodiment) are illustrated and described as distributed, independent components of content provider 902, any one or more of the managers, servers, and monitors can be implemented together as a multi-functional component of content provider 902. Additionally, any one or more of the managers, servers, and monitors described with reference to system 900 can implement features and embodiments of multi-DVR node communication.

The television-based client systems 904(1-N) can be implemented to include a television-based client device 926 and a display device 928 (e.g., a television, LCD, and the like). A television-based client device 926 of a television-based client system 904 can be implemented in any number of embodiments, such as a set-top box, a digital video recorder (DVR) and playback system, an appliance device, a gaming system, and as any other type of client device that may be implemented in a television-based entertainment and information system. In an alternate embodiment, client system 904(N) is implemented with a computing device 930 as well as a television-based client device 926. Additionally, any of the television-based client devices 926 of a television-based client system 904 can implement features and embodiments of multi-DVR node communication as described herein.

Although embodiments of related media content assets have been described in language specific to features and/or methods, it is to be understood that the subject of the appended claims is not necessarily limited to the specific features or methods described. Rather, the specific features and methods are disclosed as exemplary implementations of related media content assets.

1. A method comprising:
maintaining an index of media content assets which are associated with defining attributes where at least some of the media content assets in the index have in common one or more of the defining attributes;
relating the media content assets in the index to one another based on the defining attributes;
receiving a request from a client device for related media content assets which are related to a selected media content asset playing at the client device;
processing the request to identify one or more defining attributes of the selected media content asset, and to identify the related media content assets in the index which have in common the one or more defining attributes of the selected media content asset; and
communicating identifiers of the related media content assets to the client device in response to the request.

2. A method as recited in claim 1, further comprising relating the media content assets in the index prior to receiving the request from the client device.

3. A method as recited in claim 1, further comprising relating the media content assets in response to receiving the request from the client device.

4. A method as recited in claim 1, further comprising relating the media content assets in the index based on at least one of the defining attributes which include: matching text of the media content assets; a duration of time that the media content assets are viewed; a time of day that the media content assets are viewed; a day of a week that the media content assets are viewed.

5. A method as recited in claim 1, further comprising relating the media content assets in the index based on at least one of the defining attributes which include: title, description, lead actor, director, producer, rating, reviews, program category, language.

6. A method as recited in claim 1, wherein the media content assets in the index include programs and merchandise items, and the method further comprising relating the programs in the index with the merchandise items.

7. A method comprising:
displaying a selected media content asset at a client device;
receiving a viewer-initiated request for related media content assets which are related to the selected media content asset;
communicating the viewer-initiated request to a provider that determines the related media content assets;
receiving a response from the provider which includes identifiers of the related media content assets determined to be related to the selected media content asset; and
displaying at least one of the related media content assets indicated by the identifiers while the selected program is displaying at the client device.

8. A method as recited in claim 7, wherein the displaying of the at least one of the related media content assets includes at least one of: displaying a related media content asset as a picture-in-picture; displaying the related media content assets as pictures-in-pictures in a film strip format; displaying the related media content assets as pictures-in-pictures in a mosaic format.

9. A method as recited in claim 7, wherein the displaying of the at least one related media content assets includes displaying a program that is related to the selected media content asset and displaying a merchandise item that is related to the selected media content asset.

10. A method as recited in claim 7, the method further comprising navigating through the related media content assets to display the related media content assets while the selected program is displaying at the client device.

11. A method as recited in claim 7, further comprising selecting a related media content asset from the display of the at least one related media content assets.

12. A method as recited in claim 11, further comprising displaying the related media content asset selected from the display of the at least one related media content assets.

13. A method as recited in claim 7, further comprising maintaining the display of the selected program while displaying the at least one related media content asset.

14. A method as recited in claim 7, wherein the provider which communicates the response that includes the identifiers does not communicate the related media content assets to the client device.

15. A system comprising:
a client device configured to:
receive a viewer-initiated request for related media content assets which are related to a selected media content asset displaying at the client device;
communicate the viewer initiated request to a provider that identifies the related media content assets;
receive a response from the provider which includes identifiers of the related media content assets; and
a provider configured to:
receive the viewer-initiated request for the related media content assets;
process the viewer-initiated request to identify one or more defining attributes of the selected media content asset which is displaying at the client device, and to identify in an index the related media content assets which have in common the one or more defining attributes of the selected media content asset; and
communicate identifiers of the related media content assets to the client device in response to the viewer-initiated request.

16. A system as recited in claim 15, wherein the provider is further configured to relate the media content assets in the index to one another based on the defining attributes prior to receiving the viewer-initiated request for the related media content assets from the client device.

17. A system as recited in claim 15, wherein the provider is further configured to relate the media content assets in the index to one another based on the defining attributes in response to receiving the viewer-initiated request for the related media content assets from the client device.

18. A system as recited in claim 15, wherein the provider is further configured to identify the media content assets in the index based on at least one of the defining attributes which include: matching text of the media content assets; a duration of time that the media content assets are viewed; a time of day that the media content assets are viewed; a day of a week that the media content assets are viewed.

19. A system as recited in claim 15, wherein the client device is further configured to display at least one of the related media content assets as a picture-in-picture while displaying the selected media content at the client device.

20. A system as recited in claim 15, wherein the client device is further configured to continue displaying the selected program while navigating through the related media content assets and displaying the related media content assets.
